(19) United States
(12) Patent Application Publication
(10) Pub. No.: US 2002/0110430 A1
(43) Pub. Date: Aug. 15, 2002

(54) Ceramic cutting tool for the working of metals

(76) Inventor: Juergen Otto Neumann, Dachau (DE)

Correspondence Address: Schwegman, Lundberg, Woessner & Kluth, P.A., P.O. Box 2938, Minneapolis, MN, 55402, US

(21) Appl. No.: 10/041,764

(22) Filed: Jan. 7, 2002

Related U.S. Application Data
(63) Continuation of application No. 09/513,649, filed on Feb. 25, 2000, now abandoned.

(30) Foreign Application Priority Data
Feb. 15, 2000 (DE) 10006645.3
Feb. 15, 2000 (DE) 20002631.3

(51) Int. Cl. B23B 27/14; B23P 15/28

(52) U.S. Cl. 407/116; 407/119

(57) ABSTRACT

A ceramic cutting tool for metal working having at least one machining guide stage (chip control), wherein the machining guide stage has a recess and at least one cutting edge and/or cutting tip. The machining guide stage can be designed as a partially or filly encircling edge near the outer marginal area of at least one outer surface of the cutting tool. Such a cutting tool provides broken cuttings in use.

### FIELD OF THE INVENTION

The subject of the present invention pertains to a ceramic cutting tool, its use and a process for working metal parts.

### BACKGROUND

It is known that ceramic tools are used for working metal surfaces, especially for the cutting of metals. Disadvantageous in this regard is that in the working of metal parts with ceramic tools, so-called process cuttings, which as a rule develop in a spiral form, are formed during the cutting process. Such process cuttings normally have a length of several meters. In the cutting or metalworking process, these process cuttings bend and/or form accumulations of process cuttings that wrap around the ceramic cutting tool and/or impede the cutting path. On the one hand, this interferes with and/or even interrupts the essential cooling of the ceramic cutting tool, which, due to the high temperatures developed in the cutting process, can lead to a premature material fatigue of the ceramic cutting tool or even to an indirect destruction of the ceramic cutting tool. Furthermore, the process cutting can make its way into the cutting path, i.e., in front of the ceramic cutting tool and thus, e.g., cause the ceramic cutting tool to divert from its exact cutting position. In addition, the dimensional stability of the cutting line is essentially adversely influenced by the high compressive force of the ceramic cutting tool on the metal surface to be worked, in that the ceramic tool is forced away from the preestablished cutting line due to the developing tensile and compressive forces, so that in order to observe the dimensional specifications the executed cutting line must be reworked several times. In order to obtain clean cut edges, the ceramic cutting tool must be frequently reapplied and/or areas already worked must be reworked. This results in serious time delays.

The use of hard metal cutting tools is also known. Such hard metal cutting tools have the disadvantage that the cutting speed is very low. Normally, the cutting speed is 25-35 m/min. In the working of metal surfaces with such hard metal cutting tools, many meter-long, uncontrolled, and as a rule, spiral process cuttings are formed with a length frequently in a range of 5-10 m or even longer. These uncontrolled process cuttings form material accumulation in the form of an unordered ball of wool. These in turn have the disadvantage that they hamper the cooling even more severely than the process cuttings and can wind around the hard metal cutting tool with the consequences cited above. This is especially very disadvantageous in the case of precision parts, on which clean or smooth edges are necessary. In further amplification, forces, such as tensile and compressive forces, build up in the cutting of the material with a hard metal cutting tool, which dislodge the cutting tool from its preestablished position, so that the dimensional specifications of the executed cutting line must be repeatedly reworked. In order to obtain clean cut edges, the hard metal cutting tool must be frequently reset and/or areas already worked must be reworked. In light of the considerations described above and the already low cutting speed with hard metal cutting tools, this implies a considerable delay of the working process. Accordingly, in actual practice and despite the known disadvantages, ceramic cutting tools are used almost exclusively.

The objective of the present invention is to shorten the working process time of metal parts with ceramic cutting tools and to lower the developed forces, such as tensile and compressive forces, while improving the cutting precision or the dimensional stability of the ceramic cutting tool.

### SUMMARY OF THE INVENTION

This objective is realized according to the invention with a ceramic cutting tool, which has at least one machining guide stage with a recess and at least one cutting edge and/or cutting tip.

Additional advantageous embodiments of the use and process are set forth in the following claims, to which reference is made in full measure.

Metal parts in the sense of this description includes all types of metals and metal mixtures, especially steel and stainless sled. Naturally, non-metallic parts can also be worked with the ceramic cutting tools according to the invention if they have adequate hardness.

In fact, it was surprisingly found that, with the ceramic cutting tools with a machining guide stage according to the invention, process cuttings, such as are formed with hard metal cutting tools or without a machining guide, are not formed.

Fully unanticipated by the person skilled in the art, when ceramic cutting tools according to the invention with at least one machining guide are used, neither process cuttings nor the especially disadvantageous uncontrolled process cuttings but rather broken cuttings are formed. These broken cuttings, which are formed as a result o f using the machining guide stage of the ceramic cutting tool according to the invention, often have a length of ≦10 cm, preferably <1 cm and ideally <1 mm.

In view of the high cutting speeds when the ceramic cutting tools without machining guide stage are used and the essentially higher temperatures developed during the cutting process than with hard metal cutting tools, adequate cooling is absolutely necessary, since an interruption in cooling can lead to destruction of the cutting tool. Therefore, process cuttings with ceramic cutting tools are especially disadvantageous due to the higher cutting speeds, since they form piles of material in front of the ceramic cutting tools, with which the cooling can be adversely affected or even interrupted.

It is advantageous, when the ceramic cutting tools with at least one machining guide stage according to the invention are used if the broken cuttings formed from the metal surface being worked are flushed away from the working area with the coolant. This is especially advantageous since, unlike the process cuttings, the broken cuttings can be flushed away together with the coolant, so that the cutting process call continue unhampered. Accordingly, the service life, e.g., of such ceramic cutting tools with a machining guide stage is extended, since the formed broken cuttings do not or at least do not critically detract from the cooling of the ceramic cutting tools with machining guide stage according to the invention.

A further advantage of the ceramic cutting tools with machining guide stage according to the invention is that the developed compressive and tensile forces are significantly lower than those developed in the working of metal surfaces with ceramic cutting tools without a machining guide stage under otherwise identical conditions or specifications.

In the working of metal surfaces with lathes using hard metal cutting tools with and without machining guide stage or ceramic cutting tools without a machining guide stage, high compressive and tensile forces develop, due to which a metal part with wall thickness of up to and even beyond 6 mm in the machining area, i.e., the area in which the hard metal cutting tool with and without machining guide stage or a ceramic cutting tool without a machining guide stage contacts the cutting line, takes on a slight curvature.

Furthermore, the cutting tool is held by a retaining element, while this retaining element is itself or by means of additional connector elements connected to the lathe.

The high pressures developed in the working of metals on a lathe using hard metal or ceramic cutting tools are partly responsible for the fact that the cutting tool, the retaining element and/or the connector element can easily bend. As a result of such bends, the cutting tool is forced out of the preestablished cutting line, so that the dimensional retention, i.e., the defined preestablished tolerance values, is not observed. In the case of ceramic cutting tools with a cutting speed of 300 m/min, e.g., the drift in the case of stainless steel with a wall thickness of 4-6 mm is approximately 3/100 mm (0.03 mm). When, e.g., a cutting operation with a ceramic cutting tool without a machining guide stage is run for 4 min on a lathe, the distance of 1200 m must be remachined about 2-4 times to achieve the surface quality necessary in the case of precision parts, such as must be remachined for flywheels for the high-pressure compressors of transmissions with a so-called zero cut. With ceramic cutting tool exchange and working times of 3×4 min, the result is an overall machining time of approximately 18 min for an ordinary process working unit.

Specifically in the production of precision parts, which require clean or smooth cut edges, the use of hard metal cutting tools with and without machining guide stage or ceramic cutting tools without a machining guide stage is especially disadvantageous.

Contrary thereto, the ceramic cutting tool with machining guide stage according to the invention, due to the minimal pressures developed, is not diverted or not seriously diverted from its preestablished working position, so that a reworking in order to achieve the predetermined cut line is not necessary or markedly less often necessary in comparison with a ceramic cutting tool without a machining guide stage under identical conditions.

On an ordinary lathe with a normal process working unit of 4 min and a speed of 300 m/min, in view of the prevailing slight pressures when the ceramic cutting tool with a machining guide stage according to the invention, the dimensional specifications are observed in comparison with a ceramic cutting tool without a machining guide stage. In other words, when the ceramic cutting tool with a machining guide stage according to the invention is used, the total duration of the process working unit for 1200 m is only 4 min and not 18 min, since reworking steps or zero steps, etc., are not necessary to achieve the surface quality essential for precision parts, such as flywheels of high-pressure compressors in transmissions. When one considers that several hundred to several thousand process working units are frequently run per metal part, the result can be working time savings of several hours.

With the ceramic cutting tools with machining guide stage according to the invention, the diversion from the dimensionally specified cut line of the metal part, in comparison with an otherwise identical ceramic cutting tool without machining guide stage, is less by a factor of at least 1.5, preferably by at least a factor of 2, even more preferably by at least a factor of 5, and ideally by a factor of at least 10.

A further advantage is that with the ceramic cutting tool with a machining guide stage according to the invention, the dimensional retention is significantly more exact when compared to constructively identical ceramic cutting tools without machining guide stage, so that the precision metal parts produced according to the process of the invention already have better surface quality with one process working unit, i.e., clean or smooth cut edges, with simultaneously increased processing speed.

The forms of the ceramic cutting tools with machining guide stage according to the invention can be configured as desired. As a rule, the forms are so designed that, when turned on a lathe with tile ceramic cutting tools with machining guide stage according to the invention, the metal part acquires the desired contour. Thus, the ceramic cutting tool with machining guide stage according to the invention has a rounded form on the cutting edge of the ceramic cutting tool when the metal part is to be curved on the cut line, or a slanted form when the metal part is to be slanted on the cut line.

Especially preferred is a ceramic cutting tool with machining guide stage designed in one piece.

In another embodiment form according to the invention, the machining guide stage is formed close to the outer marginal area of at least one outer surface of the ceramic cutting tool.

In another embodiment form of the ceramic cutting tool according to the invention, the machining guide stage is designed as an outer edge running completely or partially around at least one outer surface of the ceramic cutting tool.

Preferably, the recess of the machining guide stage is a U-shaped or V-shaped depression, while at least one of the inwardly oriented walls of the machining guide stage is preferably rounded and/or slanted, preferably at an angle of 3-10°. The separation of the inside walls in the area of the upper opening of the recess of the machining guide stage ranges between 0.05 mm and 1 cm. The upper opening of the recess of the machining guide stage preferably ranges between 0.5 mm and 2 mm. Acceptable ranges are between 0.1 mm and 1 mm, as well as between 0.2 mm and 4 mm. However, the separation of the inside walls in the area of the upper opening of the recess of the machining guide stage can also be below 0.05 mm or above 1 cm. It is feasible that the separation of the inside walls in the area of the upper opening of the recess of the machining guide stage might be in a range of 1-10 cm or even greater.

Preferably, the outer inside walls and the opposing inner inside walls of the machining guide stage have the same height. However, the height of the outer inside wall and the height of the opposing inner inside wall of the machining guide stage can also be different. That is, the outer inside wall and/or the opposing inner inside wall of the machining guide stage can be greater and/or less than the opposite height of the wall.

The walls of the machining guide stage can be straight, slanted and/or rounded. Preferably, the outer outside wall of the machining guide stage is rounded and/or straight. The outer inside wall of the machining guide track is preferably oriented inwardly and is slanted and/or rounded in the lower area. The inner inside wall is preferably straight.

The depth of the recess of the machining guide stage ranges from 0.01 mm to 0.1 mm measured from the upper edge of the outer inside wall. The depth of the recess of the machining guide stage can be (0.05 mm or) 0.1 mm. Depending upon the cutting tool, the depth can be 1-10 cm. Preferential ranges are between 0.05 mm and 0.5 mm or 0.1 mm.

The ceramic cutting tools with machining guide stage according to the invention are suitable for use in the working of metal parts, especially for the cutting and/or fashioning of recesses in metal parts. For example, the ceramic cutting tools with machining guide stage according to the invention can be used for preliminary working, preliminary finish working and/or finish working. For preliminary and preliminary finish working, ceramic cutting tool punch plates with machining guide stage are especially suited.

The ceramic cutting tools with machining guide stage according to the invention are especially well suited for preliminary turning and/or finish turning.

In the working of metal parts, the cutting speed of the ceramic cutting tool with machining guide according to the invention is ≧50 m/min, preferably ≧100 m/min, more preferably between 150 m/min and 350 m/min, and ideally 300 m/min. The cutting speed can also be >350 m/min.

Normally, the ceramic cutting tool according to the invention penetrates into the surface of the metal part to be worked to a depth of ≧0.01 mm to 10 cm, preferably ≧0.1 mm, more preferably ≧0.05 mm, still more preferably between 0.1 mm and 0.5 mm, ideally to a depth of 0.25 mm. The penetration depth can be between 0.01 mm and 1 cm, preferably between 0.1 mm and 6 mm, more preferably between 0.3 mm and 4 mm. The maximum penetration depth can also be >1 cm. The maximum penetration depth depends upon the respective lathe used.

Ceramic cutting tools with machining guide stage according to the invention are illustrated in FIGS. 1-8.

### BRIEF DESCRIPTION OF THE DRAWINGS

FIG. 1 depicts a lathe.

FIG. 2 depicts a ceramic cutting tool with a machining guide stage.

FIG. 3 depicts an enlargement of the machine guiding stage of FIG. 2.

FIG. 4 depicts a ceramic cutting tool with a machining guide stage.

FIG. 5 depicts a ceramic cutting tool with a machining guide stage.

FIG. 6 depicts a ceramic cutting tool with a machining guide stage suitable for punching.

FIG. 7 depicts a ceramic cutting tool with a machining guide stage suitable for punching.

FIG. 8 depicts a ceramic cutting tool with a machining guide stage suitable for punching.

### DETAILED DESCRIPTION

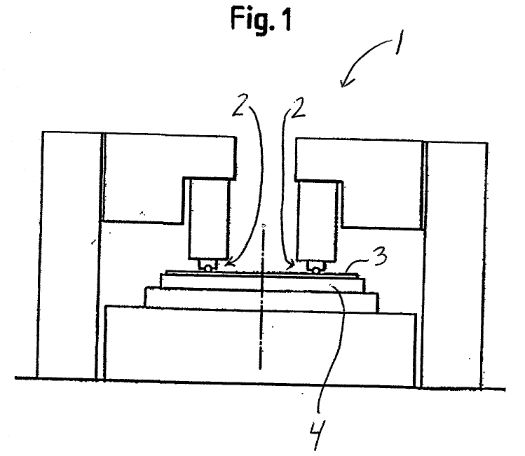

FIG. 1 shows a lathe (1), in which two ceramic cutting tools with machining guide stage (2) are rigidly yet removably installed. The ceramic cutting tools with machining guide stage (2) cut into the turning metal part (3), which is immovably secured on a surface plate (4).

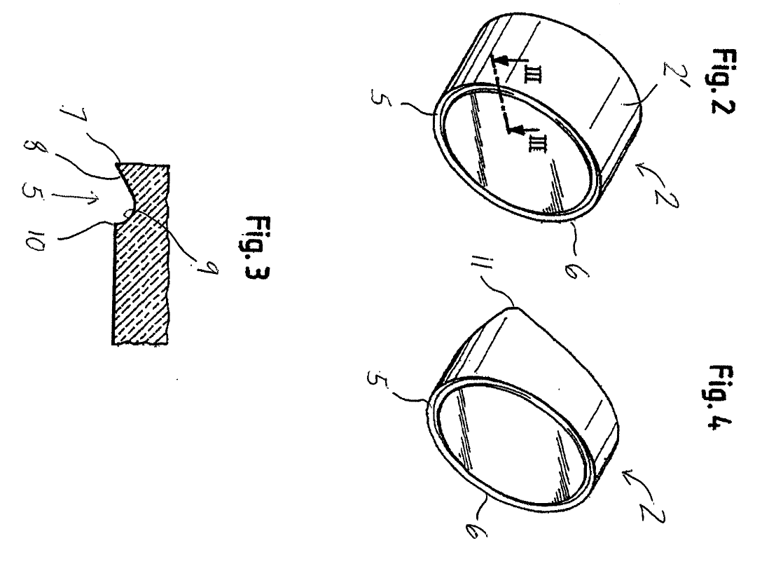

FIG. 2 shows a ceramic cutting tool (2) with a cylindrical ceramic body (2′) machining guide stage (chip breaker) (5) and an encircling cutting edge (6). With the cutting edge (6), the ceramic cutting tool (2) with machining guide stage (5) cuts into the metal part (3) (not shown in FIG. 2).

FIG. 3 shows the machining guide stage (5) of the ceramic cutting tool (2) with the cutting edge (6) enlarged. The outer wall (7) and the inner wall (10) of the machining guide stage (5) have the same height. The inside of the outer wall (7) is slanted (8) in its upper area and has a rounding (9) in its lower area. The inside of the inner wall (10) of the machining guide stage (5) is straight in its upper area and has a similar curvature (9) in its lower area.

FIG. 4 shows a ceramic cutting tool (2) with machining guide stage (5) and an encircling cuffing edge (6). With the cutting edge (6), the ceramic cutting tool (2) with machining guide stage (5) cuts into the metal part (3) (not shown in FIG. 4). In the rear area, the ceramic cutting tool (2) with machining guide stage (5) tapers to a pointed cap (11). This has the advantage that the ceramic cutting tool (2) with machining guide stage (5) can be better secured in the lathe and, due to the pointed cap (11), is thus secured against slipping and/or twisting.

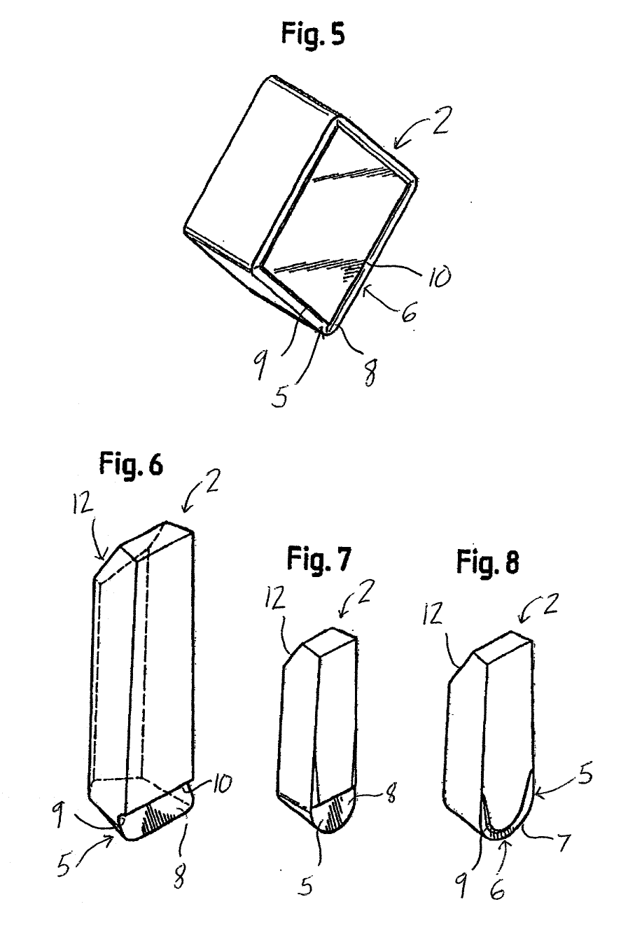

FIG. 5 shows a ceramic cutting tool (2) with a cutting edge (6). The outer wall 7 and the inner wall (10) of the machining guide stage (5) have the same height. The inside outer wall (7) is slanted (8) in its upper area and has a rounding (9) in its lower area. The inside inner wall (10) of the machining guide stage (5) is straight in its upper area and has a similar curvature in its lower area.

FIG. 6 shows a ceramic cutting tool (2) with machining guide stage (5) and a cutting edge (6), while the cutting edge (6) is a gradient and has a rounded form only on the comers. This ceramic cutting tool (2) with machining guide stage (5) has an essentially rod-like form and is especially well suited for use as a punching tool. With the cutting edge (6), the ceramic cutting tool (2) with machining guide stage (5) cuts into the metal part (3) (not shown in FIG. 6). The outer inside wall (7) is slanted (8) in its upper area and has a rounding (9) in its lower area. The inner inside wall (10) of the machining guide stage (5) also has a curved area (9). The ceramic cutting tool (2) with machining guide stage (5) tapers to a beveling (12) in its rear area. This has the advantage that the ceramic cutting tool (2) with machining guide stage (5) can be better attached and, due to the beveling (12), is secured against slipping and/or twisting.

FIG. 7 shows a ceramic cutting tool (2) with machining guide stage (5) and a cutting edge (6), while the cutting edge (6) has a curved form. This ceramic cutting tool (2) with machining guide stage (5) has an essentially rod-shaped form and is especially well suited as a punching tool. With the cutting edge (6), the ceramic cutting tool (2) with machining guide stage (5) cuts into the metal part (3) (not shown in FIG. 7). The inner outside wall (7) is slanted (8). The inner inside wall (10) of the machining guide stage (5) has a curved area (9). The ceramic cutting tool (2) with machining guide stage (5) tapers to a beveling (12) in the rear area. This has the advantage that the ceramic cutting tool (2) with machining guide stage (5) can be better attached and, due to the beveling (12), is secured against slipping and/or twisting.

FIG. 8 shows a ceramic cutting tool (2) with machining guide stage (5) and a cutting edge (6). The cutting edge (6) has a horseshoe-like form, which is curved in its rear area and is straight to the ends. This ceramic cutting tool (2) with machining guide stage (5) has an essentially rod-shaped form and is suitable for use as a punching tool and a cutting tool. With the cutting edge (6), the ceramic cutting tool (2) with machining guide stage (5) cuts into the metal part (3) (not shown in FIG. 8). The inner outside wall (7) is slanted (8) and curved (9) in the manner of an arch in its lower area. The inner inside wall (10) of the machining guide stage (5) is essentially straight. The ceramic cutting tool (2) with machining guide stage (5) tapers to a beveling (12) in its rear area. This has the advantage that the ceramic cutting tool (2) with machining guide stage (5) can be better attached and, due to the beveling (12), is secured against slipping and/or twisting.

1. Ceramic cutting tool suitable for metal working, characterized in that the ceramic cutting tool has at least one machining guide stage, where the machining guide stage has a recess and at least one cutting edge and/or cutting tip.

2. Ceramic cutting tool according to claim 1 where the ceramic cutting tool is designed in one piece.

3. Ceramic cutting tool according to claim 1 or 2, where the machining guide stage is designed as a partially or fully encircling edge near the outer marginal area of at least one outer surface of the ceramic cutting tool.

4. Ceramic cutting tool according to one of the preceding claims, where the machining guide stage is designed as a partially or fully encircling outer edge of at least one outer surface of the ceramic cutting tool.

5. Ceramic cutting tool according to one of the preceding claims, where the recess of the machining guide stage is preferably a U-shaped or a V-shaped depression; preferably the recess of the machining guide stage has at least one inwardly oriented wall, which is rounded and/or slanted, preferably at an angle of 3-10°.

6. Ceramic cutting tool according to one of the preceding claims, where the separation of the inner walls in the area of the upper opening of the recess of the machining guide stage is in a range between 0.05 mm and 10 cm and/or the depth of the recess of the machining guide stage is in a range between 0.01 mm and 2 mm.

7. Use of the ceramic cutting tool, according to one of the preceding claims, for working metal parts, especially for cutting of metal parts and/or fashioning recesses in metal parts.

8. Process for the working of metal parts, characterized in that the ceramic cutting tool according to claims 1-6 is used for the working of a metal part with a cutting speed of ≧50 m/min, preferably ≧100 m/min, more preferably ≧400 m/min, even more preferably between 150 m/min and 350 m/min and ideally 300 m/min.

9. Process for the working of medal parts according to claim 9, where the ceramic cutting tool cuts into the surface of the metal part to be worked to a depth of ≧0.01 mm to 10 cm, preferably ≧0.1 mm, more preferably ≧0.5 mm, still more preferably between 0.1 mm and 0.5 mm and ideally between 0.25 mm.

10. A cutting tool, comprising:
a cylindrical ceramic body having an outward surface, the surface having an outer edge area;
a machining guide stage at the outer edge area, wherein the machining guide stage fully encircles the surface, the machining guide stage includes a recess defined by an outer, first wall and an inner, second wall, the machining guide stage further includes a cutting edge at the first wall, the cutting edge fully encircling the surface.

11. The cutting tool of claim 10, wherein the first wall and the second wall have the same height.

12. The cutting tool of claim 10, wherein a surface of the first wall and a surface of the second wall are coplanar.

13. The cutting tool of claim 10, wherein the recess is one of a U-shaped or V-shaped depression.

14. The cutting tool of claim 10, wherein the second wall includes a rounded area.

15. The cutting tool of claim 10, wherein the recess includes an inner wall slanted at an angle in the range of 3 degrees to 10 degrees.

16. The cutting tool of claim 15, wherein a surface of the first wall and a surface of the second wall are coplanar, and wherein the inner wall slants relative to the coplanar surfaces of the first wall and the second wall.

17. The cutting tool of claim 10, wherein the recess includes an upper opening defined by the first and second walls, the upper opening being in a range between 0.01 mm and 10 cm.

18. The cutting tool of claim 17, wherein the recess has a depth in a range between 0.01 mm and 2 mm.

19. The cutting tool of claim 10, wherein the recess includes opposed first and second inner walls, the first inner wall being separated from the second inner wall in a range between 0.1 mm and 1 mm.

20. The cutting tool of claim 10, wherein the recess has a depth in a range between 0.01 mm and 2 mm.

21. The cutting tool of claim 10, wherein the recess has a depth in a range between 0.05 mm and 0.1 mm.

22. A cutting tool, comprising:
a cylindrical ceramic body having an outward surface, the surface having a disk shape, an outer edge area, and a cutting edge at the outer edge area fully encircling the surface;
a machining guide stage at the outer edge area inwardly from the cutting edge, wherein the machining guide stage includes a recess between an outer, first wall and an inner, second wall, the first wall and the second wall each have a coplanar surface, the recess is defined by a third wall and a fourth wall joined together at a point having a depth in the range of 0.01 mm to 2 mm and separated from each other at the surface in the range of 0.05 mm and 1 cm, and the recess fully encircles the surface.

23. The cutting tool of claim 22, wherein at least one of the third wall and the fourth wall is slanted at an angle of 3 to 10 degrees relative to the coplanar surfaces of the first and second walls.

24. The cutting tool of claim 22, wherein at least one of the third and fourth walls are rounded.

25. The cutting tool of claim 22, wherein the second wall includes a surface that is continuous and disk shaped.

26. The cutting tool of claim 22, wherein the depth is less than 0.1 mm.

27. A process for working metal parts, comprising applying a cutting tool according to any of the preceding claims to a metal work piece including setting the cutting speed at a rate of greater than or equal to 50 m/min.

28. The process of 27, wherein setting the cutting speed includes setting the cutting speed at about 300 m/min.

29. The process of 28, wherein setting the cutting speed includes cutting into the surface of the metal work part to a depth in the range of 0.01 mm to 10 cm.
